(19) United States
(12) Patent Application Publication
(10) Pub. No.: US 2023/0206553 A1
(43) Pub. Date: Jun. 29, 2023

(54) MULTI-PLANE MAPPING FOR INDOOR SCENE RECONSTRUCTION

(71) Applicant: INTEL CORPORATION, Santa Clara, CA (US)

(72) Inventor: Xuesong SHI, Beijing (CN)

(73) Assignee: INTEL CORPORATION, Santa Clara, CA (US)

(21) Appl. No.: 17/927,405

(22) PCT Filed: Jul. 22, 2020
(86) PCT No.: PCT/CN2020/103432

§ 371 Date: Nov. 23, 2022

(51) Int. Cl. G06T 17/00; G06T 15/00

(52) U.S. Cl. CPC G06T 17/005; G06T 15/005

(57) ABSTRACT

Described herein are scene reconstruction methods and techniques for reconstructing scenes by modeling planar areas using 2.5D models and non-planar areas with 3D models. In particular, depth data for an indoor scene is received. Planar areas of the indoor scene are identified based on the depth data and modeled using a 2.5D planar model. Other areas are modeled using 3D models and the entire scene is reconstructed using both the 2.5D models and the 3D models.

### BACKGROUND

Many modern computing applications reconstruct a scene for use in augmented reality (AR), virtual reality (VR), robotics, autonomous applications, etc. However, conventional scene reconstruction, such as, dense three-dimensional (3D) reconstruction have a very high computational requirement in both compute and memory requirements. Thus, present techniques are not suitable for real-time scene reconstruction for many applications, such as, mobile applications lacking the necessary compute and memory resources.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a scene reconstruction device 100 in accordance with one embodiment.

FIG. 2 illustrates an indoor scene 200 in accordance with one embodiment.

FIG. 3 illustrates a routine 300 in accordance with one embodiment.

FIGS. 4A and 4B illustrate an octree model 402 comprising using voxels and nodes in accordance with one embodiment.

FIG. 5 illustrates an octree model 500 in accordance with one embodiment.

FIG. 6 illustrates a routine 600 in accordance with one embodiment.

FIG. 7 illustrates a plane model 700 in accordance with one embodiment.

FIGS. 8A, 8B, 8C, and 8D illustrate an indoor scene 800 in accordance with one embodiment.

FIG. 9 illustrates a computer-readable storage medium 900 in accordance with one embodiment.

FIG. 10 illustrates a diagrammatic representation of a machine 1000 in the form of a computer system within which a set of instructions may be executed for causing the machine to perform any one or more of the methodologies discussed herein, according to example embodiments.

### DETAILED DESCRIPTION

Scene reconstruction can sometimes be referred to as dense mapping, and operates to digitally reconstruct a physical environment based on images or 3D scans of the physical environment.

In general, the present disclosure provides scene reconstruction methods and techniques, systems and apparatus for reconstructing scenes, and a two and a half dimensional (2.5D) model for modeling areas (e.g., planar areas, non-planar areas, boundary areas, holes in a plane, etc.) of a scene. With some examples, the 2.5D model can be integrated into a scene reconstructions system and can used to model a portion of a scene while other portions of the scene can be modeled by a 3D model.

The present disclosure can provide scene reconstruction for applications such as, robotics, AR, VR, autonomous driving, high definition (HD) mapping, etc. In particular, the present disclosure can provide a scene reconstructions system where all or portions of the scene are modeled using a 2.5D model, as described in greater detail herein. As such, the present disclosure can be implemented in systems where compute resources are limited, such as, for example, by systems lacking a dedicated graphics processing unit (GPU), or the like.

Reference is now made to the detailed description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to or combined, without limiting the scope to the embodiments disclosed herein. The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

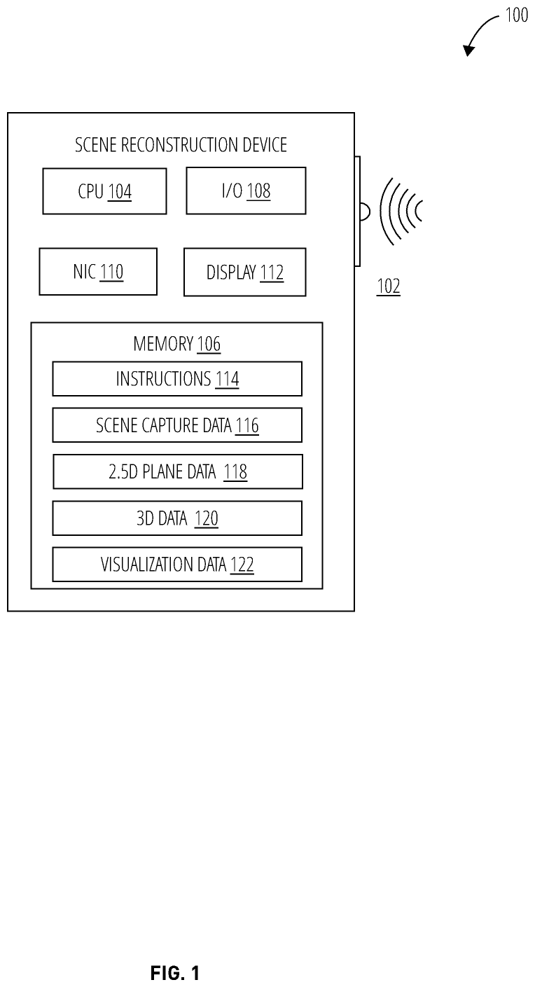

FIG. 1 illustrates a scene reconstruction device 100, in accordance with embodiments of the disclosure. In general, scene reconstruction device 100 can be embodied by any of a variety of devices, such as, a wearable device, a head-mounted device, a computer, a laptop, a tablet, a smart phone, or the like. Furthermore, it is to be appreciated that scene reconstruction device 100 can include more (or less) components than those shown in FIG. 1. Although not depicted herein, scene reconstruction device 100 can include a frame wearable by a user (e.g., adapted to be head-worn, or the like) where the display is mounted to the frame such that the display is visible to the user during use (or while worn by the user).

Scene reconstruction device 100 includes scene capture device 102, processing circuitry 104, memory 106, input and output devices 108 (I/O), network interface circuitry 110 (NIC), and a display 112. These components can be connected by a bus or busses (not shown). In general, such a bus system provides a mechanism for enabling the various components and subsystems of scene reconstruction device 100 to communicate with each other as intended. In some examples, the bus can be any of a variety of busses, such as, for example, a PCI bus, a USB bus, a front side bus, or the like.

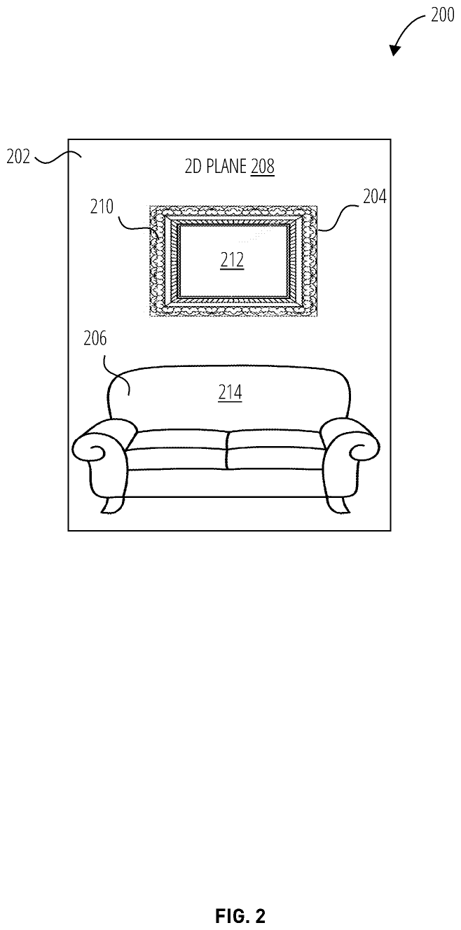

Scene capture device 102 can be any of a variety of devices arranged to capture information about a scene. For example, scene capture device 102 can be a radar system, a depth camera system, a 3D camera system, a stereo camera system, or the like. Examples are not limited in this context. In general, however, scene capture device 102 can be arranged to capture information about the depth of a scene, such as, an indoor room (e.g., refer to FIG. 2).

Scene reconstruction device 100 can include one or more of processing circuitry 104. Note, although processing circuitry 104 is depicted as a central processing unit (CPU), processing circuitry 104 can include a multi-threaded processor, a multi-core processor (whether the multiple cores coexist on the same or separate dies), an application specific integrated circuit (ASIC), a field programmable integrated circuit (FPGA). In some examples, processing circuitry 104 may include graphics processing portions and may include dedicated memory, multiple-threaded processing and/or some other parallel processing capability. In some examples, processing circuitry 104 may be circuitry arranged to perform particular computations, such as, related to artificial intelligence (AI), machine learning, or graphics. Such circuitry may be referred to as an accelerator. Furthermore, although referred to herein as a CPU, circuitry associated with processing circuitry 104 may be a graphics processing unit (GPU), or may be neither a conventional CPU or GPU. Additionally, where multiple processing circuitry 104 are included in scene reconstruction device 100, each processing circuitry 104 need not be identical.

Memory 106 can be a tangible media configured to store computer readable data and instructions. Examples of tangible media include circuitry for storing data (e.g., semiconductor memory), such as, flash memory, non-transitory read-only-memory (ROMS), dynamic random access memory (DRAM), NAND memory, NOR memory, phase-change memory, battery-backed volatile memory, or the like. In general, memory 106 will include at least some non-transitory computer-readable medium arranged to store instructions executable by circuitry (e.g., processing circuitry 104, or the like). Memory 106 could include a DVD/CD-ROM drive and associated media, a memory card, or the like. Additionally, memory 106 could include a hard disk drive or a solid-state drive.

The input and output devices 108 include devices and mechanisms for receiving input information to scene reconstruction device 100 or for outputting information from scene reconstruction device 100. These may include a keyboard, a keypad, a touch screen incorporated into the display 112, audio input devices such as voice recognition systems, microphones, and other types of input devices. In various embodiments, the input and output devices 108 may be embodied as a computer mouse, a trackball, a track pad, a joystick, wireless remote, drawing tablet, voice command system, eye tracking system, and the like. The input and output devices 108 typically allow a user to select objects, icons, control areas, text and the like that appear on the display 112 via a command such as a click of a button or the like. Further, input and output devices 108 can include speakers, printers, infrared LEDs, display 112, and so on as well understood in the art. Display 112 can include any of a devices to display images, or a graphical user interfaces (GUI).

Memory 106 may include instructions 114, scene capture data 116, 2.5D plane data 118, 3D data 120, and visualization data 122. In general, processing circuitry 104 can execute instructions 114 to receive indications of a scene (e.g., indoor scene 200 of FIG. 2, or the like) and store the indications as scene capture data 116. As a specific example, processing circuitry 104 can execute instructions 114 to receive indications from scene capture device 102 regarding a scene. Such indications can include depth information for various points in the scene. This is explained in greater detail below.

Furthermore, the processing circuitry 104 can execute instructions 114 to generate both 2.5D plane data 118 and 3D data 120. More specifically, the present disclosure provides that portions of a scene can be represented by a 2D plane, and as such, 2.5D plane data 118 can be generated from scene capture data 116 for these portions of the scene. Likewise, pother portions of the scene can be represented by 3D data, and as such, 3D data 120 can be generated from scene capture data 116 for these portions of the scene. Subsequently, visualization data 122 can be generated from the 2.5D plane data 118 and the 3D data 120. The visualization data 122 can include indications of a rendering of the scene. Visualization data 122 can be used in either a VR system or an AR system, as such, the visualization data 122 can include indications of a virtual rendering of the scene or an augmented reality rendering of the scene.

FIG. 2 depicts an indoor scene 200 that can be visualized or reconstructed by a scene reconstruction device, such as scene reconstruction device 100. It is noted that indoor scene 200 depicts a single wall of an indoor space. This is done for ease of depiction and description of illustrative examples of the disclosure. In practice however, the present disclosure can be applied to reconstruct scenes including multipole walls, objects, spaces, and the like.

Indoor scene 200 includes a wall 202, a painting 204, and a couch 206. Scene reconstruction device 100 can be arranged to capture indications of indoor scene 200, such as, indications of depth (e.g., from device 102, from a fixed reference point, or the like) of points of indoor scene 200. It is noted, that points in indoor scene 200 are not depicted for purposes of clarity. Further, the number of points, or rather, the resolution, of the scene capture device can vary.

Indoor scene 200 is used to describe illustrative examples of the present disclosure, where a scene is reproduced by representing portions of the scene as a 2D plane and other portions of the scene as 3D objects. In particular, indoor scene 200 can be reproduced by representing portions of wall 202 not covered by painting 204 and couch 206 as 2D plane 208. Further, the frame portion of painting 204 can be represented as 3D object 210 while the canvas portion of painting 204 can be represented as 2D plane 212. Likewise, couch 206 can be represented as 3D object 214. By representing portions of indoor scene 200 as 2D planes, the present disclosure provides for real-time and/or on-device scene reconstructions without the need for large scale computational resources (e.g., GPU support, or the like).

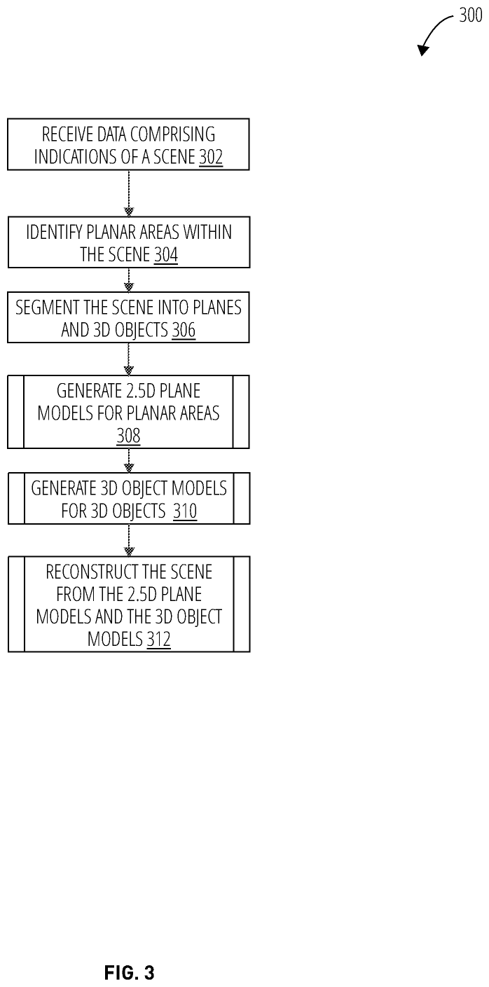

FIG. 3 illustrates a routine 300 that can be implemented by a device to reconstruct a scene, according to examples of the present disclosure. For example, scene reconstruction device 100 can implement routine 300. Although, routine 300 is described with reference to scene reconstruction device 100 of FIG. 1 and indoor scene 200 and FIG. 2, routine 300 could be implemented to reconstruct a scene by a device different from that depicted here. Examples are not limited in this respect.

Routine 300 can begin at block 302 “receive data comprising indications of a scene” where data including indications of a scene can be received. For example, processing circuitry 104 can execute instructions 114 to receive scene capture data 116. As a specific example, processing circuitry 104 can execute instructions 114 to cause scene capture device 102 to capture indications of a scene (e.g., indoor scene 200). Processing circuitry 104 can execute instructions 114 to store the captured indications as scene capture data 116.

Continuing to block 304 “identify planar areas within the scene” planar areas in the scene can be identified. In general, for indoor scenes, planar surfaces (e.g., walls, floors, ceilings, etc.) typically occupy a significant portion of the non-free space. These such planar areas are identified at block 304. For example, processing circuitry 104 can execute instructions 114 to identify areas within scene capture data 116 having a contagious depth value, thereby forming a surface. In a specific example, depth values within a threshold value of each other across a selection of points will be identified as a planar surface. Referring to FIG. 2, processing circuitry 104 can execute instructions 114 to analyze scene capture data 116 and identify 2D plane 208 and 2D plane 212 from depth values associated with points corresponding to these surfaces.

Continuing to block 306 “segment the scene into planes and 3D objects” the scene can be segmented into planes and 3D objects. For example, points within the scene capture data 116 associated with the planar areas identified at block 304 can be segmented from the other points of the scene. Processing circuitry 104 can execute instructions 114 to identify or mark points of scene capture data 116 associated with the identified planes. As a specific example, the depth value of points associated with the identified planar areas can be multiplied by negative 1 (−1). In conventional systems, depth values are not negative. As such, a negative depth value can indicate inclusion within the planar areas. As another specific example, processing circuitry 104 can execute instructions 114 to generate 2.5D plane data 118 for 2D plane 208 and 2D plane 212.

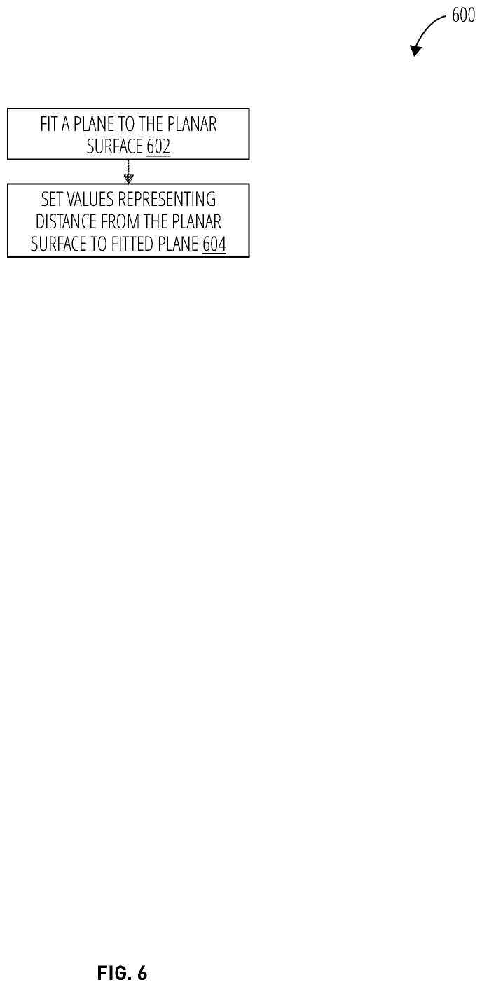

Continuing to subroutine block 308 “generate 2.5D plane models for planar areas” 2.5D plane models for the identified planar areas can be generated. For example, processing circuitry 104 can execute instructions 114 to generate 2.5D plane data 118 from points of scene capture data 116 associated with the identified planar areas. This is described in greater detail below, for example, with respect to FIG. 6. Continuing to subroutine block 310 “generate 3D object models for 3D objects” 3D object models can be generated for the 3D object areas identified at block 304. For example, processing circuitry 104 can execute instructions 114 to generate 3D data 120 from scene capture data 116 for areas not identified as planar (or for areas identified as 3D objects). As a specific example, processing circuitry 104 can execute instructions 114 to generate 3D data 120 for 3D object 210 and 3D object 214.

Continuing to subroutine block 312 “reconstruct the scene from the 2.5D plane models and the 3D object models” the scene can be reconstructed (e.g., visualized, or the like) from the 2.5D plane models and the 3D object models generated at subroutine block 308 and subroutine block 310. More particularly, processing circuitry 104 can execute instructions 114 to generate visualization data 122 from 2.5D plane data 118 generated at subroutine block 308 and the 3D data 120 generated at subroutine block 310. With some examples, processing circuitry 104 can execute instructions 114 to display the reconstructed scene (e.g., based on visualization data 122, or the like) on display 112. More specifically, processing circuitry 104 can execute instructions 114 to display the reconstructed indoor scene 200 as part of a VR or AR image.

It is noted, that routine 300 depicts various subroutines for modeling objects or planes in a scene and for reconstructing the scene from these models. In scene reconstruction, scene capture data 116 typically includes indications of points, point cloud, or surfels. Said differently, point cloud is mostly used to model raw sensor data. From point cloud data, voxels can be generated. More specifically, volumetric methods can be applied to digitalize the 3D space (e.g., the point cloud) with a regular grid, with each grid cell named a voxel. For each voxel, a value is stored to represent either the probability of this place being occupied (occupancy grid mapping), or its distance to nearest surface (signed distance function (SDF), or truncated SDF (TSDF)).

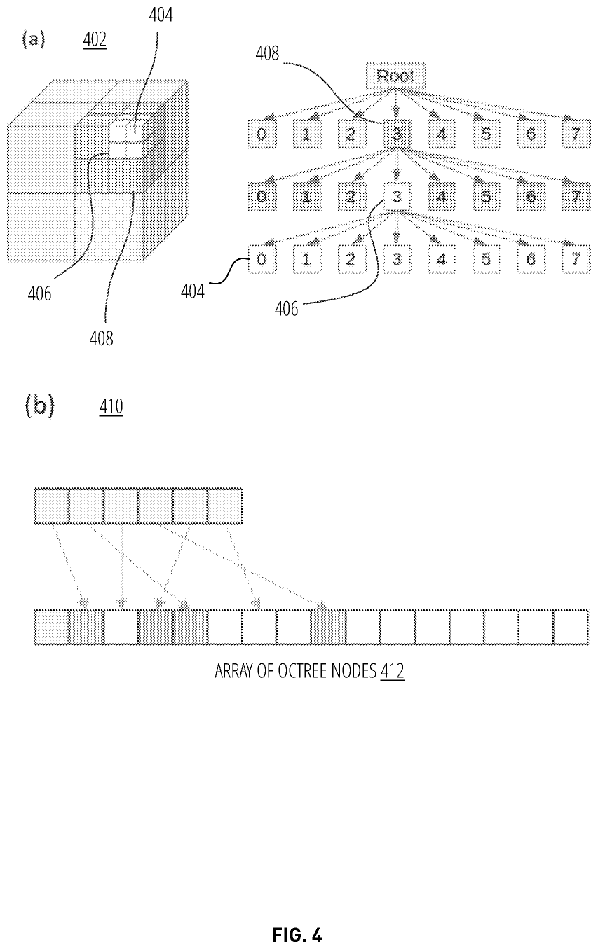

It is noted, that with conventional volumetric method techniques, it is impractical to generate voxels for a room-size or larger indoor space. That is, the memory of modern desktop computers is insufficient to store indications of all the voxels. As such, voxels may be compacted using octrees and hashing. FIG. 4A illustrates an octree model 402 where eight adjacent voxels (e.g., voxel 404, etc.) with the same value (e.g. all with occupancy probability of 1.0, or all with occupancy probability of 0.0) can be aggregately represented with only one node 406. Compaction can be furthered by compacting eight adjacent nodes (e.g., node 406, etc.) with the same value into a larger node 408.

FIG. 4B illustrates a hashing hash table 410 where only voxels with non-free values are stored. Specifically, hash table 410 only stores indications of nodes in array of octree nodes 412 that are non-free. With some examples, voxels can be compacted using both hashing and octrees, as indicated in FIG. 4B.

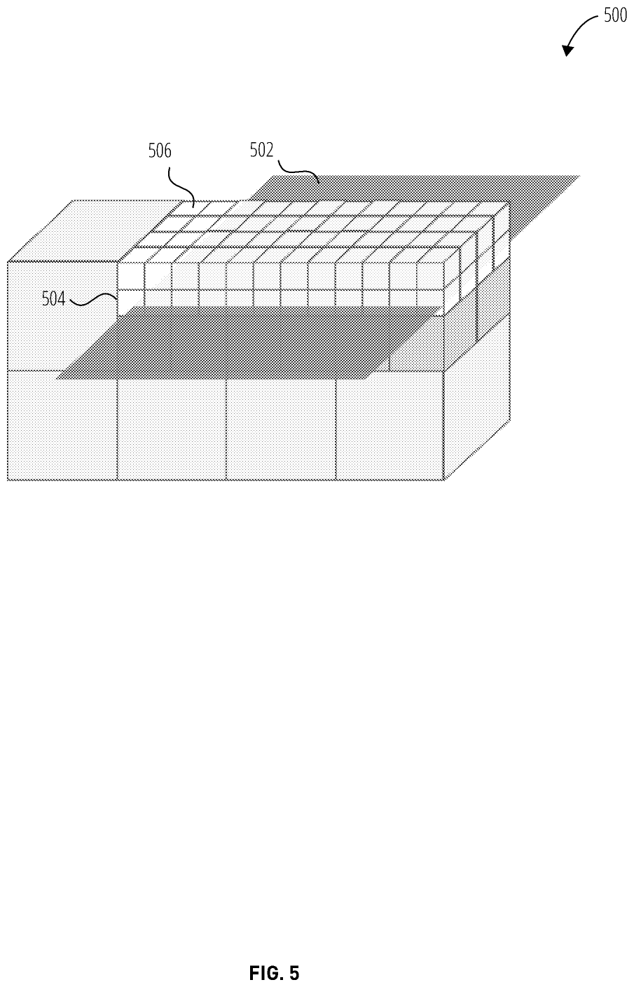

It is noted that the difficulty with representing indoor scenes as planar is that planar surfaces in the real world are usually not strictly planar. For example, attached on walls there can be power plugs, switches, paintings (e.g., painting 204, or the like), etc. Furthermore, using octree models, representation of large planar surfaces cannot be compressed as the large planar surface splits all the nodes it passes through. For example, FIG. 5 illustrates an octree model 500 with a plane 502. As the plane 502 splits all the nodes (e.g., node 504) it passes through, the octree model 500 must represent each of these nodes at the finest resolutions (e.g., at the voxel 506 level, or the like). As such, efficiency savings from using an octree are lost where planes are represented.

FIG. 6 illustrates a routine 600 that can be implemented by a device to reconstruct a scene, according to examples of the present disclosure. For example, scene reconstruction device 100 can implement routine 600. Although, routine 600 is described with reference to scene reconstruction device 100 of FIG. 1 and indoor scene 200 and FIG. 2, routine 600 could be implemented to reconstruct a scene by a device different from that depicted here. Examples are not limited in this respect. Furthermore, with some examples, routine 300 of FIG. 3 can implement routine 600 as subroutine block 308. For example, routine 600 can be implemented to generate 2D plane models for portions or areas of an indoor scene 200 identified as planar (e.g., 2D plane 208 and 2D plane 212).

In general, routine 600 provides that for indoor scenes (e.g., walls, floors, ceilings, etc.), which usually occupy a significant portion of the non-free space be modeled as a surface. As noted above, these large planar surfaces cannot be compressed using octree or hashing. For example, for octree maps, their efficiency comes from the fact that only nodes near the surface of object are split into the finest resolution. However, as detailed above (e.g., see FIG. 5) a large planar surface splits all the nodes it passes through, as such, these nodes also must be represented in the finest resolution. Thus, the present disclosure provides that a planar area (e.g., a perfect plane, an imperfect plane, or the like) be modeled as a surface with a 2D grid, whose orientation is aligned with the plane fit to the planar area of the surface.

Routine 600 can begin at block 602 “fit a plane to the planar surface” where a plane (e.g., defined in the X and Y coordinates, or the like) can be fit to the planar surface. For example, processing circuitry 104 can execute instructions 114 to fit a plane to the 2D plane 208 or the 2D plane 212. Continuing to block 604 “set values representing distance from the planar surface to fitted plane” where values indicating a distance between the actual surface (e.g., 2D plane 208, 2D plane 212, or the like) and the fit plane (e.g., the plane generated at block 602. For example, processing circuitry 104 can execute instructions 114 to set a value representing the distance from the actual surface to the fitted plane at the center position of the cell. With some examples, this value can be based on Truncated Signed Distance Function (TSDF). Additionally, with some examples, a weight can be set at block 604 where the weight is indicative of the confidence of the distance value (e.g., the TDSF value, or the like) and the occupancy state. More particularly, TDSF can mean the signed distance from the actual surface to the fitted plane. In some examples, the TDSF value can be updated whenever there is an observation of the surface near the fitted plane at the center position of corresponding cell. Furthermore, weights can mean a confidence and occupancy. Regarding the weights, with some examples, the weights may have an initial value of 0, which can be increased (e.g. w+=1) when there is an observation of the surface fit to the plane at this position, or decreased (e.g. w*=0.5, or the like to converge to 0 with infinite observations) when this position is observed to be free (unoccupied). A cell can be considered to be free if its weight is below a threshold (e.g., w<1.0).

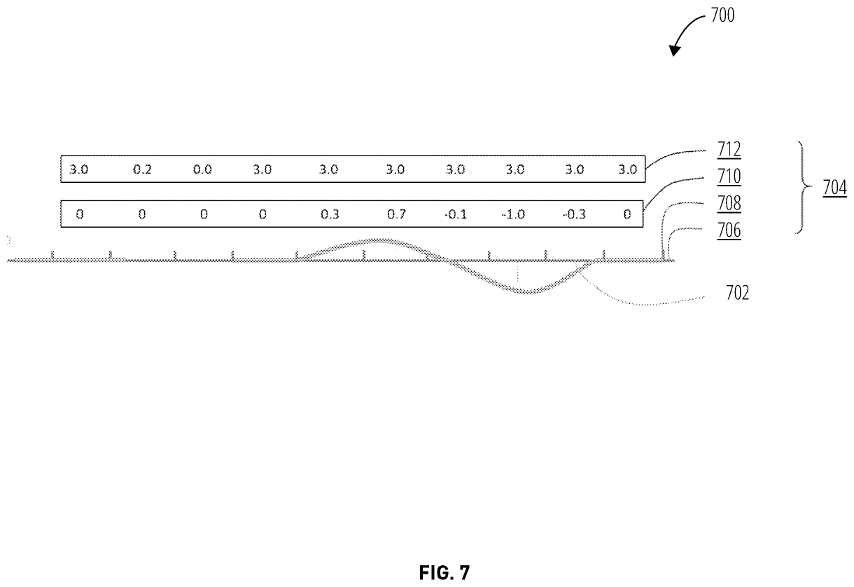

As a specific example, FIG. 7 illustrates a graphical representation of a plane model 700, which can be generated based on the present disclosure. As illustrated, the plane model 700 depicts a 2D planar surface 702. It is noted, that the present disclosure can be applied to 2D planar surfaces that are not “perfectly” planar, as illustrated in this figure. A 2D planar surface modeled by the 2.5D plane data 118, such as, for example, the 2D planar surface 702 can have non-planar areas (e.g., holes, 3D surface portions, etc.), as would be encountered by a real “mostly planar” surface in the physical world. The plane model 700 further depicts a 2.5D plane model 704 comprising a fit plane 706, a 2D grid 708, TDSF values 710, and weights 712.

The 2.5D plane model 704 is updated when there is an aligned observation from a 3D sensor (e.g., scene capture device 102, or the like). Alignment is described in greater detail below. With some examples, updating a 2.5D plane model 704 can be based on the following pseudocode.
Input: a set of points; sensor position; 2.5D plane model 704
Output: updated 2.5D plane model 704
For each point P:
   Pₚₗₐₙₑ=to plane frame(P)
   if P_{plane.}z<−σ://point is behind the plane; σ is a tolerance factor
      Pcross=find_intersect (ray_from_sensor_to_point, plane)
      update_free(to_plane_frame(Pcross))
   else if P_{plane.}z<=σ://point is near the plane
      update_occupied(Pplane)
   else: do nothing//point is in front of the plane;
update_occupied(P):
   cell=get_cell_with_coordinates(P.x, P.y)
   weight_new =cell.weight+1
   cell.tsdf=(cell.tsdf*cell.weight+P.z)/weight_new
   cell.weight=weight_new
update_free(P):
   cell=get cell with coordinates(P.x, P.y)
   cell.weight=cell.weight*0.5

In the pseudocode above, the function “to_plane_frame” denotes the process of transforming a given point into the coordinate frame of the plane, which is defined in a way that the fit plane is spanned by the X-and Y-axis, and the Z-axis points towards the sensor. More specifically, the fit plane 706 is represented in the X-axis and Y-axis where the Z-axis points towards scene capture device 102. It is noted that the above pseudocode are just one example of an update algorithm and the present disclosure could be implemented using different updating algorithms under the same principle of the TSDF and weight definition.

Returning to FIG. 3, routine 300 includes subroutine block 310 for generating 3D object models and also subroutine block 312 for reconstructing the scene from the 2.5D plane model and the 3D object models. It is important to note that when a point in the frame data (e.g., scene capture data 116) has triggered an update_occupied operation to any plane model, (i.e. this point has been associated with a registered plane), then it should not trigger any similar update occupied operations to the primary 3D model. In one examples, points triggering an update occupied operation can be marked. For example, the value of the point (e.g., as indicated in scene capture data 116, or the like) can be multiplied by negative 1 (−1). As all depth values are positive, then negative depth values will trigger only “update_free” operations, which can be arranged to operate on the absolute value of the depth value. As such, the 2.5D plane data 118 and points from scene capture data 116 are excluded from the primary 3D data 120.

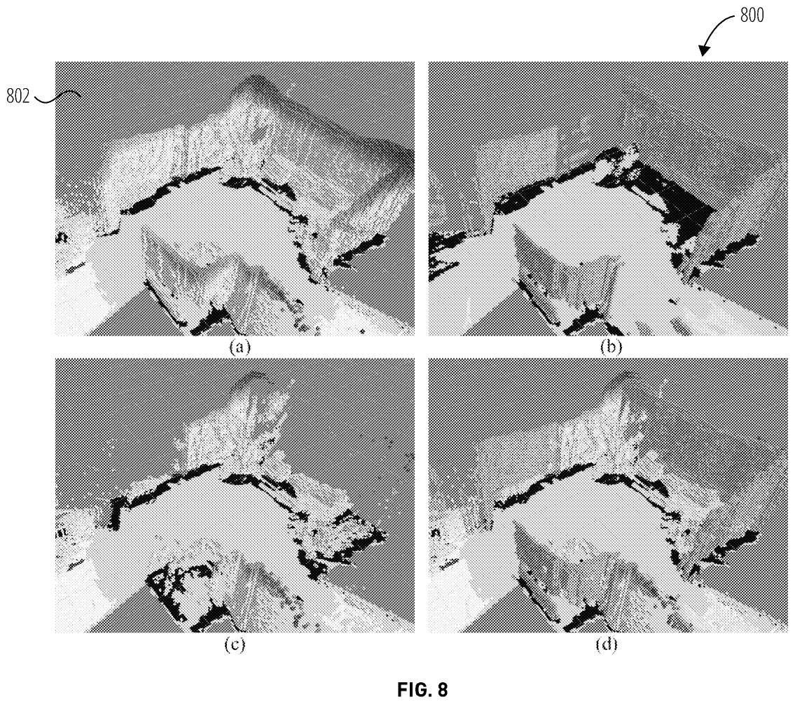

FIG. 8A, FIG. 8B, FIG. 8C, and FIG. 8D illustrate an example reconstruction of an indoor scene 800. In particular, FIG. 8A illustrates a 3D model reconstructed scene 802, or rather, indoor scene 800 reconstructed from depth data (e.g., scene capture data 116, or the like) entirely using 3D models (e.g., 3D data 120, or the like). FIG. 8B illustrates a portion of indoor scene 800 reconstructed from depth data (e.g., scene capture data 116, or the like) using 2.5D models (e.g., 2.5D plane data 118, or the like), as described herein. Likewise, FIG. 8C illustrates the other portion of indoor scene 800 reconstructed from depth data (e.g., scene capture data 116, or the like) using 3D models (e.g., 3D data 120, or the like). The entire indoor scene 800 can be reconstructed from the 2.5D model data (e.g., 2.5D plane data 118, or the like) and the 3D model data (e.g., 3D data 120, or the like) as illustrated in FIG. 8D.

It is noted, that the number of occupied voxels represented by 3D data is significantly reduced (e.g., FIG. 8C versus FIG. 8A). As such, a significant reduction in compute resources can be realized by splitting the scene reconstruction into 3D models and 2.5D models as described herein. Furthermore, it is noted that the 2.5D model (e.g., plane model 700, or the like) can model non-strictly planar surfaces, even with noisy input data, as evidenced by FIG. 8B. Furthermore, of note indoor scene 800 reconstructed using both 3D and 2.5D modeling (e.g., FIG. 8D) is almost identical to the indoor scene 800 reconstructed using entirely 3D models (e.g., FIG. 8A) except that walls from the hybrid 3D/2.5D reconstruction are single-layer voxelized as opposed to thicker. However, thicker walls are an artifact introduced by sensor noises under the probabilistic occupancy model. The reconstructed surfaces themselves are the same. The present disclosure can be combined with 3D noise reduction algorithms, for example, to further reduce noisy voxels in the 3D data (e.g., as depicted in FIG. 8C, or the like).

The present disclosure provides for real-time (e.g., live, or the like) indoor scene (e.g., indoor scene 800, or the like) reconstruction without the need for a GPU. For example, indoor scene 800 was reconstructed in real-time by integrating over 20 depth camera frames per second on a single core of a modern CPU. An additional advantage of the present disclosure is that it can be used to further enhance understanding of the scene by machine learning applications. For example, as planar surfaces (e.g., walls, floors, ceilings, etc.) can be explicitly modeled, the machine learning agent can further infer the spatial structure of the scene, such as to segment rooms based on wall information, to ignore walls, floors, ceilings, and focus on things in the room, or the like. As a specific example, a machine learning agent can infer planar surfaces (e.g., walls, ceilings, floors, etc.) from the 2.5D plane data 118 and can then focus on objects represented in the 3D data 120, for example, to identify objects within an indoor scene without needing to parse the objects out from the planar surfaces.

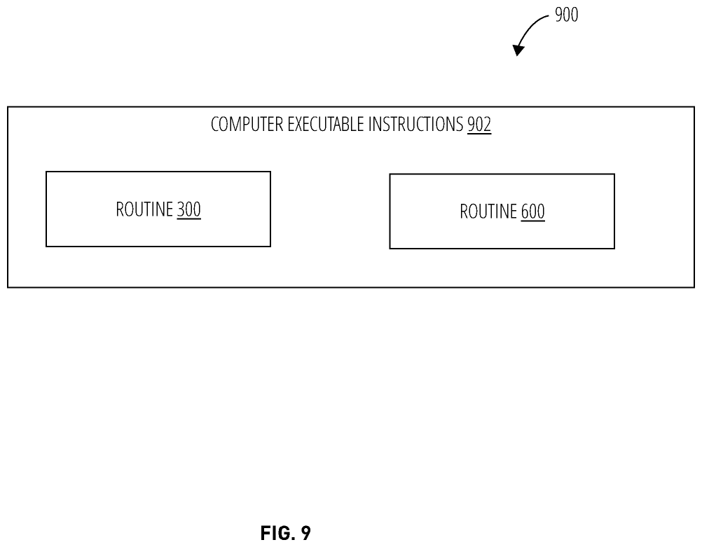

FIG. 9 illustrates computer-readable storage medium 900. Computer-readable storage medium 900 may comprise any non-transitory computer-readable storage medium or machine-readable storage medium, such as an optical, magnetic or semiconductor storage medium. In various embodiments, computer-readable storage medium 900 may comprise an article of manufacture. In some embodiments, 700 may store computer executable instructions 902 with which circuitry (e.g., processing circuitry 104, or the like) can execute. For example, computer executable instructions 902 can include instructions to implement operations described with respect to routine 300, and/or routine 600. Examples of computer-readable storage medium 900 or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions 902 may include any suitable type of code, such as source code, compiled code, interpreted code, executable code, static code, dynamic code, object-oriented code, visual code, and the like.

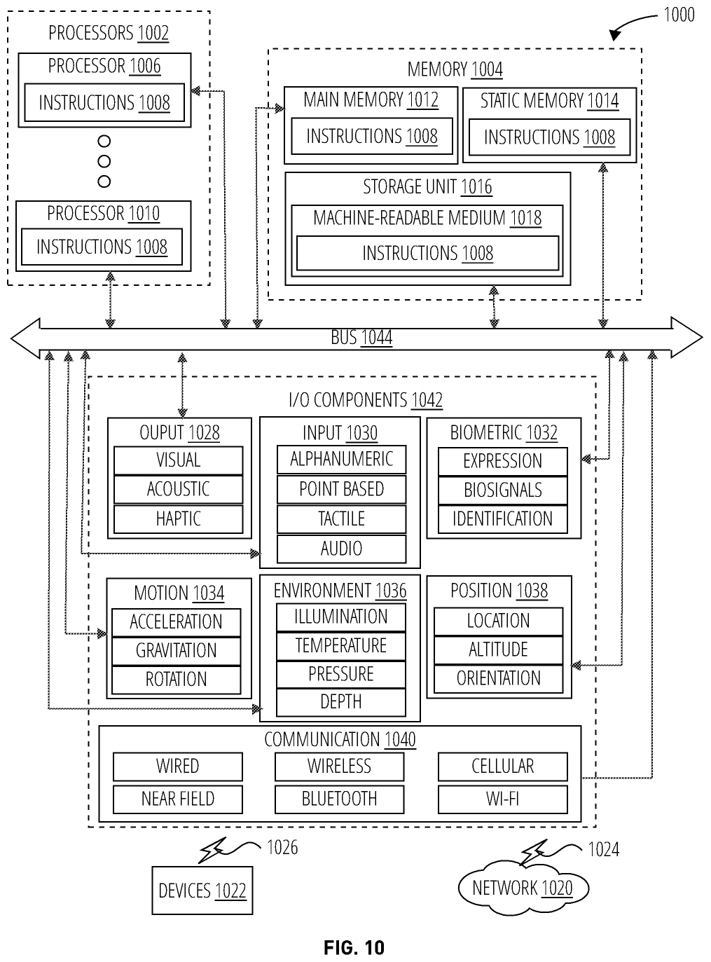

FIG. 10 illustrates a diagrammatic representation of a machine 1000 in the form of a computer system within which a set of instructions may be executed for causing the machine to perform any one or more of the methodologies discussed herein. More specifically, FIG. 10 shows a diagrammatic representation of the machine 1000 in the example form of a computer system, within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute routine 300 of FIG. 3, routine 600 of FIG. 6, or the like. More generally, the instructions 1008 may cause the machine 1000 to reconstruct an indoor scene (e.g., indoor scene 200, indoor scene 800, or the like) using 2.5 planar models (e.g., 2.5D plane data 118) and 3D models (e.g., 3D data 120) based on depth data (e.g., scene capture data 116).

The instructions 1008 transform the general, non-programmed machine 1000 into a particular machine 1000 programmed to carry out the described and illustrated functions in a specific manner. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines 1000 that individually or jointly execute the instructions 1008 to perform any one or more of the methodologies discussed herein.

The machine 1000 may include processors 1002, memory 1004, and I/O components 1042, which may be configured to communicate with each other such as via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), a neural-network (NN) processor, an artificial intelligence accelerator, a vision processing unit (VPU), a graphics processing unit (GPU) another processor, or any suitable combination thereof) may include, for example, a processor 1006 and a processor 1010 that may execute the instructions 1008.

The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof. Additionally, the various processors (e.g., 1002, 1010, etc.) and/or components may be included on a System-on-Chip (SoC) device.

The memory 1004 may include a main memory 1012, a static memory 1014, and a storage unit 1016, both accessible to the processors 1002 such as via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones will likely include a touch input device or other such input mechanisms, while a headless server machine will likely not include such a touch input device. It will be appreciated that the I/O components 1042 may include many other components that are not shown in FIG. 10. The I/O components 1042 are grouped according to functionality merely for simplifying the following discussion and the grouping is in no way limiting. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), depth and/or proximity sensor components (e.g., infrared sensors that detect nearby objects, depth cameras, 3D cameras, stereoscopic cameras, or the like), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 may include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (i.e., memory 1004, main memory 1012, static memory 1014, and/or memory of the processors 1002) and/or storage unit 1016 may store one or more sets of instructions and data structures (e.g., software) embodying or utilized by any one or more of the methodologies or functions described herein. These instructions (e.g., the instructions 1008), when executed by processors 1002, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1020 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1020 or a portion of the network 1020 may include a wireless or cellular network, and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1008 may be transmitted or received over the network 1020 using a transmission medium via a network interface device (e.g., a network interface component included in the communication components 1040) and utilizing any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1008 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

The following are a number of illustrative examples of the disclosure. These examples pertain to further embodiments, from which numerous permutations and configurations will be apparent.

Example 1. A computing apparatus, the computing apparatus comprising: a processor; and a memory storing instructions that, when executed by the processor, configure the apparatus to: receive, from a depth measurement device, scene capture data comprising indications of an indoor scene; identify a planar area of the indoor scene from the scene capture data; model the planar area using a two-and-a-half-dimensional (2.5D) model; identify a non-planar area of the indoor scene from the scene capture data; model the non-planar area of the indoor scene using a three-dimensional (3D) model; and generate visualization data comprising indications of a digital reconstruction of the indoor scene based on the 2.5D model and the 3D model.

Example 2. The computing apparatus of claim 1, model the planar area using the 2.5D model comprising: fit a planar surface to the planar area; and set, for each a plurality of points on the plane, a distance from the fit plane to the planar surface.

Example 3. The computing apparatus of claim 2, comprising derive the distance from the fit plane to the planar surface based on a truncated signed distance function (TSDF).

Example 4. The computing apparatus of claim 2, comprising set, for each of the plurality of points on the plane, a weight value, wherein the weight value comprising an indication of a confidence of the distance.

Example 5. The computing apparatus of claim 1, wherein the scene capture data comprises a plurality of points, the method comprising: mark ones of the plurality of points associated with the planar area; and identify the non-planar area from the ones of the plurality of points that are not marked.

Example 6. The computing apparatus of claim 1, model the non-planar area using the 3D model comprising deriving voxel values and node values representing the non-planar area.

Example 7. A computer implemented method, comprising: receiving, from a depth measurement device, scene capture data comprising indications of an indoor scene; identifying a planar area of the indoor scene from the scene capture data; modeling the planar area using a two-and-a-half-dimensional (2.5D) model; identifying a non-planar area of the indoor scene from the scene capture data; modeling the non-planar area of the indoor scene using a three-dimensional (3D) model; and generating visualization data comprising indications of a digital reconstruction of the indoor scene based on the 2.5D model and the 3D model.

Example 8. The computer implemented method of claim 7, modeling the planar area using the 2.5D model comprising: fitting a planar surface to the planar area; and setting, for each a plurality of points on the plane, a distance from the fit plane to the planar surface.

Example 9. The computer implemented method of claim 8, comprising deriving the distance from the fit plane to the planar surface based on a truncated signed distance function (TSDF).

Example 10. The computer implemented method of claim 8, comprising setting, for each of the plurality of points on the plane, a weight value, wherein the weight value comprising an indication of a confidence of the distance.

Example 11. The computer implemented method of claim 7, wherein the scene capture data comprises a plurality of points, the method comprising: marking ones of the plurality of points associated with the planar area; and identifying the non-planar area from the ones of the plurality of points that are not marked.

Example 12. The computer implemented method of claim 7, modeling the non-planar area using the 3D model comprising deriving voxel values and node values representing the non-planar area.

Example 13. A non-transitory computer-readable storage medium, the computer-readable storage medium including instructions that when executed by a computer, cause the computer to: receive, from a depth measurement device, scene capture data comprising indications of an indoor scene; identify a planar area of the indoor scene from the scene capture data; model the planar area using a two-and-a-half-dimensional (2.5D) model; identify a non-planar area of the indoor scene from the scene capture data; model the non-planar area of the indoor scene using a three-dimensional (3D) model; and generate visualization data comprising indications of a digital reconstruction of the indoor scene based on the 2.5D model and the 3D model.

Example 14. The computer-readable storage medium of claim 13, model the planar area using the 2.5D model comprising: fit a plane to the planar area; and set, for each a plurality of points on the plane, a distance from the fit planar surface to the planar surface.

Example 15. The computer-readable storage medium of claim 14, comprising derive the distance from the fit plane to the planar surface based on a truncated signed distance function (TSDF).

Example 16. The computer-readable storage medium of claim 14, comprising set, for each of the plurality of points on the plane, a weight value, wherein the weight value comprising an indication of a confidence of the distance.

Example 17. The computer-readable storage medium of claim 13, wherein the scene capture data comprises a plurality of points, the method comprising: mark ones of the plurality of points associated with the planar area; and identify the non-planar area from the ones of the plurality of points that are not marked.

Example 18. The computer-readable storage medium of claim 13, model the non-planar area using the 3D model comprising deriving voxel values and node values representing the non-planar area.

Example 19. An apparatus, comprising: means for receiving, from a depth measurement device, scene capture data comprising indications of an indoor scene; means for identifying a planar area of the indoor scene from the scene capture data; means for modeling the planar area using a two-and-a-half-dimensional (2.5D) model; means for identifying a non-planar area of the indoor scene from the scene capture data; means for modeling the non-planar area of the indoor scene using a three-dimensional (3D) model; and means for generating visualization data comprising indications of a digital reconstruction of the indoor scene based on the 2.5D model and the 3D model.

Example 20. The apparatus of claim 19, comprising means for fitting a planar surface to the planar area and means for setting, for each a plurality of points on the plane, a distance from the fit plane to the planar surface to model the planar area using the 2.5D model.

Example 21. The apparatus of claim 20, comprising means for deriving the distance from the fit plane to the planar surface based on a truncated signed distance function (TSDF).

Example 22. The apparatus of claim 20, comprising means for setting, for each of the plurality of points on the plane, a weight value, wherein the weight value comprising an indication of a confidence of the distance.

Example 23. The apparatus of claim 19, wherein the scene capture data comprises a plurality of points, the apparatus comprising means for marking ones of the plurality of points associated with the planar area and means for identifying the non-planar area from the ones of the plurality of points that are not marked.

Example 24. The apparatus of claim 19, comprising means for deriving voxel values and node values representing the non-planar area to model the non-planar area using the 3D model.

Example 25. A head worn computing device, comprising: a frame; a display coupled to the frame; a processor; and a memory storing instructions that, when executed by the processor, configure the apparatus to: receive, from a depth measurement device, scene capture data comprising indications of an indoor scene; identify a planar area of the indoor scene from the scene capture data; model the planar area using a two-and-a-half-dimensional (2.5D) model; identify a non-planar area of the indoor scene from the scene capture data; model the non-planar area of the indoor scene using a three-dimensional (3D) model; generate visualization data comprising indications of a digital reconstruction of the indoor scene based on the 2.5D model and the 3D model; and cause the digital reconstruction of the indoor scene to be displayed on the display.

Example 26. The head worn computing device of claim 25, wherein the head worn computing device is a virtual reality computing device or an alternative reality computing device.

Example 27. The head worn computing device of claim 25, model the planar area using the 2.5D model comprising: fit a planar surface to the planar area; and set, for each a plurality of points on the plane, a distance from the fit plane to the planar surface.

Example 28. The head worn computing device of claim 27, comprising derive the distance from the fit plane to the planar surface based on a truncated signed distance function (TSDF).

Example 29. The head worn computing device of claim 27, comprising set, for each of the plurality of points on the plane, a weight value, wherein the weight value comprising an indication of a confidence of the distance.

Example 30. The head worn computing device of claim 25, wherein the scene capture data comprises a plurality of points, the method comprising: mark ones of the plurality of points associated with the planar area; and identify the non-planar area from the ones of the plurality of points that are not marked.

Example 31. The head worn computing device of claim 25, model the non-planar area using the 3D model comprising deriving voxel values and node values representing the non-planar area.

1-25. (canceled)

26. A computing apparatus, the computing apparatus comprising:
a processor; and
a memory storing instructions that, when executed by the processor, cause the apparatus to:
receive, from a depth measurement device, scene capture data comprising indications of an indoor scene;
identify a planar area of the indoor scene from the scene capture data;
model the planar area using a two-and-a-half-dimensional (2.5D) model;
identify a non-planar area of the indoor scene from the scene capture data;
model the non-planar area of the indoor scene using a three-dimensional (3D) model; and
generate visualization data comprising indications of a digital reconstruction of the indoor scene based on the 2.5D model and the 3D model.

27. The computing apparatus of claim 26, model the planar area using the 2.5D model comprising:
fit a planar surface to the planar area; and
set, for each a plurality of points on the plane, a distance from the fit plane to the planar surface.

28. The computing apparatus of claim 27, the memory storing instructions that, when executed by the processor, cause the apparatus to:
derive the distance from the fit plane to the planar surface based on a truncated signed distance function (TSDF); and
set, for each of the plurality of points on the plane, a weight value, wherein the weight value comprising an indication of a confidence of the distance.

29. The computing apparatus of claim 26, wherein the visualization data comprises data used to render the digital reconstruction of the indoor scene to provide a graphical representation of the indoor scene for a virtual reality or alternative reality system.

30. The computing apparatus of claim 26, wherein the scene capture data comprises a plurality of points, the memory storing instructions that, when executed by the processor, cause the apparatus to:
mark ones of the plurality of points associated with the planar area; and
identify the non-planar area from the ones of the plurality of points that are not marked.

31. The computing apparatus of claim 26, model the non-planar area using the 3D model comprising deriving voxel values and node values representing the non-planar area.

32. The computing apparatus of claim 26, further comprising a head worn computing device coupled to the processor and the memory, the head worn computing device comprising a frame and a display coupled to the frame.

33. The computing apparatus of claim 32, wherein the head worn computing device is a virtual reality computing device or an alternative reality computing device.

34. A computer implemented method, comprising:
receiving, from a depth measurement device, scene capture data comprising indications of an indoor scene;
identifying a planar area of the indoor scene from the scene capture data;
modeling the planar area using a two-and-a-half-dimensional (2.5D) model;
identifying a non-planar area of the indoor scene from the scene capture data;
modeling the non-planar area of the indoor scene using a three-dimensional (3D) model; and
generating visualization data comprising indications of a digital reconstruction of the indoor scene based on the 2.5D model and the 3D model.

35. The computer implemented method of claim 34, modeling the planar area using the 2.5D model comprising:
fitting a planar surface to the planar area; and
setting, for each a plurality of points on the plane, a distance from the fit plane to the planar surface.

36. The computer implemented method of claim 35, comprising deriving the distance from the fit plane to the planar surface based on a truncated signed distance function (T SDF).

37. The computer implemented method of claim 35, comprising setting, for each of the plurality of points on the plane, a weight value, wherein the weight value comprising an indication of a confidence of the distance.

38. The computer implemented method of claim 34, wherein the scene capture data comprises a plurality of points, the method comprising:
marking ones of the plurality of points associated with the planar area; and
identifying the non-planar area from the ones of the plurality of points that are not marked.

39. The computer implemented method of claim 34, modeling the non-planar area using the 3D model comprising deriving voxel values and node values representing the non-planar area.

40. A non-transitory computer-readable storage medium, the computer-readable storage medium including instructions that when executed by a computer, cause the computer to:
receive, from a depth measurement device, scene capture data comprising indications of an indoor scene;
identify a planar area of the indoor scene from the scene capture data;
model the planar area using a two-and-a-half-dimensional (2.5D) model;
identify a non-planar area of the indoor scene from the scene capture data;
model the non-planar area of the indoor scene using a three-dimensional (3D) model; and
generate visualization data comprising indications of a digital reconstruction of the indoor scene based on the 2.5D model and the 3D model.

41. The computer-readable storage medium of claim 40, model the planar area using the 2.5D model comprising:
fit a planar surface to the planar area; and
set, for each a plurality of points on the plane, a distance from the fit plane to the planar surface.

42. The computer-readable storage medium of claim 41, comprising derive the distance from the fit plane to the planar surface based on a truncated signed distance function (TSDF).

43. The computer-readable storage medium of claim 41, comprising set, for each of the plurality of points on the plane, a weight value, wherein the weight value comprising an indication of a confidence of the distance.

44. The computer-readable storage medium of claim 40, wherein the scene capture data comprises a plurality of points, the method comprising:
mark ones of the plurality of points associated with the planar area; and
identify the non-planar area from the ones of the plurality of points that are not marked.

45. The computer-readable storage medium of claim 40, model the non-planar area using the 3D model comprising deriving voxel values and node values representing the non-planar area.
